(19) United States
(12) Patent Application Publication
(10) Pub. No.: US 2013/0107252 A1
(43) Pub. Date: May 2, 2013

(54) OPTICAL PICKUP DEVICE

(71) Applicants: Takashi AKUTSU, Ota-shi (JP); Kengo KASHIWABA, Kumagaya-shi (JP)

(72) Inventors: Takashi AKUTSU, Ota-shi (JP); Kengo KASHIWABA, Kumagaya-shi (JP)

(21) Appl. No.: 13/659,597

(22) Filed: Oct. 24, 2012

(30) Foreign Application Priority Data
Oct. 28, 2011 (JP) 2011-237101

(51) Int. Cl. G01J 3/18

(52) U.S. Cl. 356/300

(57) ABSTRACT

An optical pickup device includes: a first partition wall defining two housing portions inside a housing, and including a through-hole penetrating from a first principal surface to a second principal surface of the first partition wall; a light-emitting element holder holding a light-emitting element, including an opening through which a light beam from the light-emitting element passes, a portion of the holder surrounding the opening being in contact with a portion of the first principal surface surrounding the through-hole; and a diffraction grating whose peripheral portion is in contact with a portion of the second principal surface surrounding the through-hole. In the device, the light-emitting element holder, the first partition wall, and the diffraction grating together form a closed space, and an optical path of the light beam from a light-emission point of the light-emitting element to the diffraction grating is inside the space.

This application claims priority from Japanese Patent Application Number JP 2011-237101 filed on Oct. 28, 2011, the contents of which are incorporated herein by reference in its entirety.

### BACKGROUND OF THE INVENTION

1. Field of the Invention

The present invention relates to an optical pickup device, and particularly relates to an optical pickup device for reducing the number of components and suppressing deterioration of optical characteristics.

2. Description of the Related Art

There is an optical pickup device used in an optical disk apparatus configured to read or record a signal by irradiating a signal recording layer of an optical disk with a laser beam. Such an optical pickup device is equipped with a semiconductor laser being a light-emitting element and a diffraction grating configured to split the laser beam. For example, the semiconductor laser is held by a holder and thereby fixed in a housing. Meanwhile, the diffraction grating is embedded in a cylindrical hole which is provided in the housing and forms an optical path of the laser beam emitted from the semiconductor laser, and is fixed to the housing by use of a spring member (this technology is described for instance in Japanese Patent Application Publication No. 2005-243107 (page 11, FIG. 8)).

FIGS. 6A and 6B are views showing a conventional optical pickup device 200, particularly an example of how a light-emitting element and a diffraction grating are arranged in a housing; FIG. 6A is a plan view and FIG. 6B is a cross-sectional view taken along the line d-d of FIG. 6A.

A housing 121 is provided with multiple partition walls 121a, 121b which define housing portions 125a, 125b, 125c for housing a light-emitting element 134 and optical components.

The light-emitting element 134 is a semiconductor laser diode capable of emitting laser beams of two wavelengths, for example. The light-emitting element 134 is housed and held in a holder (laser holder) 133 in the form of a bare chip, for example.

The holder 133 is housed in the housing portion 125a of the housing 121, and fixed in the housing 121. Moreover, the holder 133 has a cylindrical opening OP, which forms an optical path of the laser beam, in its end portion from which a laser beam is emitted.

A composite component 130 using a glass plate as a base material is provided in the opening OP. The composite component 130 is one of optical components, and formed by attaching a polarization filter 132 made of a thin resin film to one principal surface of a half-wave plate 131 made of a glass plate.

The inside of the holder 133 is kept substantially hermetically sealed by the composite component 130 placed to close the opening OP. This prevents an outgas from blocking the optical path of the laser beam.

The outgas is a gas which enters the housing 121 from the outside of the housing 121 as shown by a broken arrow, such as a gas discharged by a heat dissipation member of the semiconductor laser or the like. A bottom surface 121B or a side surface 121S of the housing 121 is provided with opening as needed according to the arrangement or shapes of optical components to be housed. The outgas enters the housing 121 through these openings while containing, for example, a gas component generated from a label layer at the time of recording a label on an optical disk, a gas component generated from a signal layer at the time of signal recording, and dust floating in the air.

In the case where an optical disk apparatus has a function to cause an optical disk drive to write characters or images on a label surface of an optical disk directly without using a printer, for example, the outgas generated from a label layer, which constitutes the label surface and uses a photosensitizing agent and a heat-sensitizing agent, at the time of the writing on the label surface with a laser beam sometimes enters the housing as shown by the arrow.

In particular, in a so-called frame type of the case where the holder 133 of the light-emitting element 134, the bare chip of the light-emitting element (semiconductor laser diode) 134 is installed (or mounted) in an open base as shown in the drawing. In this case, the light-emitting element 134 cannot be hermetically sealed unlike in the case of a hermetically sealed CAN package. Thus, the outgas inevitably flows to around a light-emission point of a laser beam. In this case, a gas component or dust is attached to a light-emission end surface of the bare chip of the laser diode due to the optical tweezers effect, which blocks laser light emission and makes the laser quality worse.

In a structure employed to avoid this, i.e., to prevent the outgas from flowing to around the light-emission point of the semiconductor laser, the outgas is blocked by means of the composite component 130 using glass as a base material.

Further, a diffraction grating 135 is housed in the housing portion 125b defined by the partition walls 121a, 121b. A press member such as a plate spring 136 is fixedly attached to the diffraction grating 135 to apply an elastic force thereto. Thereby, the diffraction grating 135 is fixed to the housing 121 while being pressed by the plate spring 136.

Cylindrical through-holes PT1 and PT2 forming the optical path of the laser beam are provided in the respective partition walls 121a, 121b defining the housing portion 125b.

The laser beam having passed through the opening OP and the through-holes PT1, PT2 is reflected off a semitransparent mirror 140 and the like, and is then guided toward an objective lens 151a held by an actuator 150.

### SUMMARY OF THE INVENTION

As described previously, in order to prevent the outgas containing gas components generated from an optical disk, dust, and the like from flowing to around the light-emission point of the semiconductor laser, the conventional optical pickup device 200 shown in FIGS. 6A and 6B forms a closed space E′ inside the holder 133 by closing the opening OP of the holder 133 with the composite component 130 using glass as the base material (the closed space E′ is sealed (closed) hermetically enough to block the entry of the outgas: a region indicated by a thin broken line).

In recent years, for the purpose of reducing the cost of an optical pickup device, there has been an increasing trend to reduce optical components using relatively expensive glass plates as base materials or to form the optical components using alternative materials other than glass plates.

Further, the polarization filter 132 in the composite component 130 is a thin resin film and is thus poor in heat resistance, and has a problem that if placed near the light-emitting element 134, particularly in the hermetically sealed holder 133, the polarization filter 132 deteriorates due to the heat at over 100° generated by the light-emitting element 134.

For these reasons, the elimination of the composite component 130 in the optical pickup device 200 shown in FIGS. 6A and 6B has been considered, but there is a problem that if the composite component 130 is not provided, the entry of the outgas inside the holder 133 cannot be prevented.

Note that, although the structure using the composite component 130 has been described above, the problems are not limited to this structure. Even a structure that forms the closed space E′ by closing the opening OP of the holder 133 only with an optical component made of a glass plate (for example, a half-wave plate) has similar problems, because there is a tendency to eliminate this optical component or to form the component using a different material.

The present invention has been made with the foregoing problems taken into consideration. The problems are solved by providing an optical pickup device including: a partition wall defining two housing portions inside a housing, and having a through-hole penetrating from a first principal surface to a second principal surface of the first partition wall; a holder holding a light-emitting element, including an opening through which a light beam from the light-emitting element is to pass, a portion of the holder surrounding the opening being in contact with a portion of the first principal surface surrounding the through-hole; and a diffraction grating whose peripheral portion is in contact with a portion of the second principal surface surrounding the through-hole. In the device, the light-emitting element holder, the first partition wall and the diffraction grating form a closed space, and an optical path of the light beam from a light-emission point of the light-emitting element to the diffraction grating is inside the space.

### BRIEF DESCRIPTION OF THE DRAWINGS

FIGS. 1A and 1B are a schematic plan view and a schematic cross-sectional view showing an optical system of an optical pickup device according to an embodiment of the present invention.

FIGS. 2A and 2B are a plan view and a cross-sectional view showing the optical pickup device according to the embodiment of the present invention.

FIGS. 3A, 3B, 3C and 3D are a perspective view, a cross-sectional view, a plan view, and a plan view for describing a light-emitting element according to the embodiment of the present invention.

FIGS. 4A, 4B and 4C are a perspective view, a perspective view, and a cross-sectional view for describing a diffraction grating according to the embodiment of the present invention.

FIGS. 5A, 5B, 5C and 5D are a perspective view, a perspective view, a plan view, and a plan view for describing a press member according to the embodiment of the present invention.

FIGS. 6A and 6B are a plan view and a cross-sectional view for describing a conventional structure.

### DESCRIPTION OF THE INVENTIONS

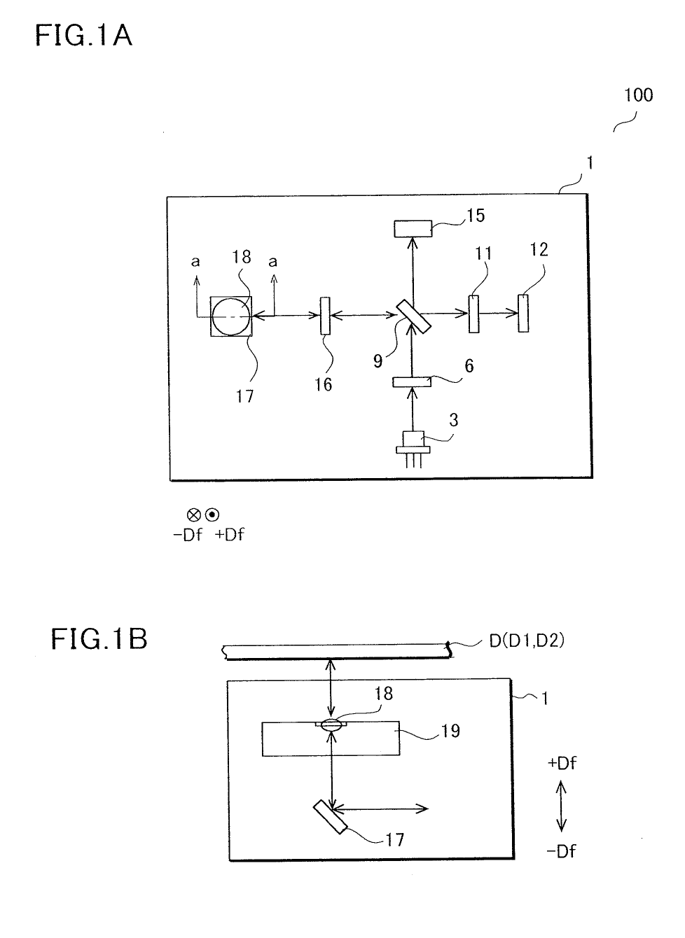

An embodiment of the present invention is described in detail by using FIGS. 1 to 5.

FIGS. 1A and 1B are schematic views showing an optical system of an optical pickup device 100; FIG. 1A is a plan view and FIG. 1B is a cross-sectional view taken along the line a-a of FIG. 1A.

The optical pickup device 100 is configured to irradiate an information recording medium (optical disk) with a laser beam and detect the laser beam reflected off the optical disk by means of the optical system formed of a light-emitting element and various optical components. A description is given here of an example of the optical pickup device 100 including the optical system configured to cause a single objective lens to focus two laser beams corresponding respectively to optical disks in compliance with the DVD (Digital Versatile Disk) standard and the CD (Compact Disc) standard.

Referring to FIG. 1A, the optical pickup device 100 has a housing 1 in which to house a light-emitting element 3 and various optical components.

The light-emitting element 3 is, for example, a semiconductor laser diode made by monolithically integrating, on one semiconductor substrate, a DVD laser diode configured to emit a laser beam with a wavelength of about 630 nm (nanometers) to 670 nm and a CD laser diode configured to emit a laser beam with a wavelength of about 770 nm to 805 nm.

A diffraction grating 6 is configured to split each of a DVD laser beam and a CD laser beam (hereinafter “laser beam”) having been emitted by the light-emitting element 3 into a zero-order light beam and positive and negative first-order light beams.

A semitransparent mirror 9 is configured to reflect part of a laser beam and transmit the rest of the laser beam, for example. The semitransparent mirror 9 is formed by using glass excellent in optical characteristics. For example, a beam splitter may be substituted for the semitransparent mirror 9.

A collimator lens 16 is configured to collimate a laser beam having entered this lens from the semitransparent mirror 9 side, and output the collimated light beam toward a reflecting mirror 17. Here, a collimated light beam means light whose rays travel substantially in parallel without dispersing with distance, and a diffusion light beam means light emitted from a light source and having rays traveling while dispersing in various directions.

The reflecting mirror 17 is placed at a position on which the collimated laser beam falls incident, and is configured to reflect the laser beam in a direction of an objective lens 18 (a direction perpendicular to a signal recording surface of an optical disk). Note that, hereinafter, directions perpendicular to the signal recording surface of an optical disk are referred to as Df directions (focusing directions), and, for the convenience of description, a direction getting closer to the optical disk is referred to as a +Df direction and a direction getting away from the optical disk is referred to as a −Df direction. Further, description is provided while directions of movement of the optical pickup device 100 over an optical disk (radial directions of the optical disk) are referred to as Dr directions (radial directions), and directions perpendicular to the Dr directions (tangential directions of the optical disk) are referred to as Dt directions (tangential directions). Furthermore, for the convenience of description, description is provided while a direction getting away from the center C of an optical disk is referred to as a +Dr direction and a direction getting closer to the center C of the optical disk is referred to as a −Dr direction.

A light-receiving element 15 is a front monitor diode on which part of a laser beam is irradiated, and is configured to detect a laser beam and apply feedback thereto for the control of the light-emitting element 3.

An astigmatism generation optical component 11 is, for example, a sensor lens, a cylindrical lens, or an AS (astigmatism) plate configured to generate astigmatism in a laser beam, and irradiate a photodetector 12 with the laser beam in which the astigmatism has been generated.

The photodetector 12 is configured to receive a laser beam reflected off an optical disk, convert the signal to an electrical signal and detect information recorded in the optical disk. The photodetector 12 is, for example, a photodiode IC (PDIC) made by combining a photodiode and an integrated circuit.

The photodiode constitutes a well-known quadripartite sensor or the like, and is configured to receive a laser beam reflected off an optical disk, convert the signal to an electrical signal, and read a signal recorded in a signal recording layer of the optical disk. The electrical signal contains a focus error signal generated by using an astigmatism method or the like, and a tracking error signal generated by using a 3-beam method or the like. A focusing control operation is carried out based on the focus error signal, and a tracking control operation is carried out based on the tracking error signal. Various such methods of generating these signals and control operations carried out based on these signals are well known, and thus a description thereof is omitted.

Referring to FIG. 1B, the objective lens 18 is configured to focus a laser beam having been reflected off the reflecting mirror 17 on a signal part of an optical disk D. In other words, a DVD laser beam having been emitted from the light-emitting element 3 is irradiated on a signal recording layer, which is provided in a DVD-standard optical disk D1, as a focusing spot by the focusing operation of the objective lens 18. Meanwhile, a CD laser beam having been emitted from the light-emitting element 3 is irradiated on a signal recording layer, which is provided in a CD-standard optical disk D2, as a focusing spot by the focusing operation of the objective lens 18. Note that the optical disk D is a generic term for the optical disk D1 and the optical disk D2.

The objective lens 18 is mounted in a lens holder (not illustrated), and the lens holder (not illustrated) is movably supported by an actuator 19.

The actuator 19 includes, for example, the lens holder (not illustrated) in which to mount the objective lens 18; coils (not illustrated) configured to drive the lens holder with an electromagnetic force generated by an electric current flowing therethrough; a magnet facing the coils and configured to constantly generate a magnetic flux; and a yoke to which the magnet is attached.

The focusing operation of the optical pickup device 100 is described with reference to FIGS. 1A and 1B.

A laser beam having been outputted from the light-emitting element 3 passes through the diffraction grating 6, is reflected off the semitransparent mirror 9 at a substantially right angle, and enters the collimator lens 16. The laser beam is then reflected off the reflecting mirror 17 at a substantially right angle (in the +Df direction), and is irradiated on the optical disk D while focused by the objective lens 18.

Meanwhile, part of the laser beam having been outputted from the light-emitting element 3 passes through the semitransparent mirror 9, and is irradiated on the light-receiving element 15.

The laser beam having been reflected off the optical disk D (returning light) passes through the objective lens 18, the reflecting mirror 17, the collimator lens 16, the semitransparent mirror 9, and the astigmatism generation optical component 11, and is irradiated on the photodetector 12.

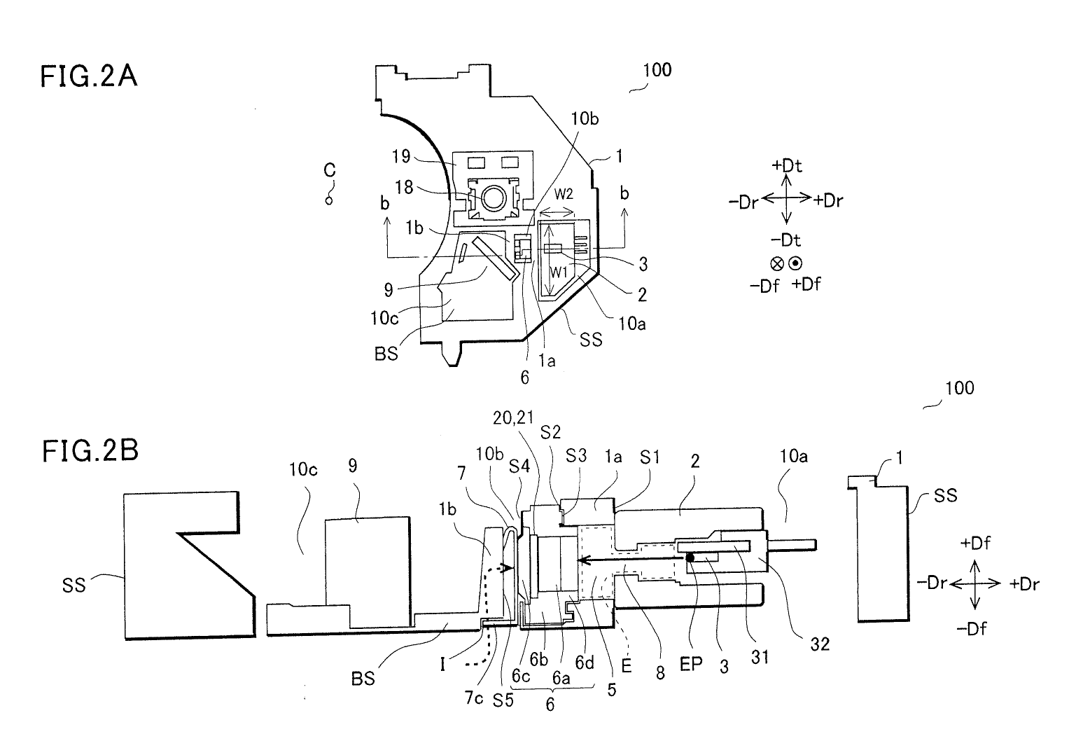

FIGS. 2A and 2B are views for describing the placement of a holder 2 of the light-emitting element 3 and the diffraction grating 6 inside the housing 1 in this embodiment; FIG. 2A is a plan view of the inside of the housing 1; and FIG. 2B is a cross-sectional view of the inside of the housing 1 taken along the line b-b of FIG. 2A. Note that, in the drawings mentioned below, components other than a main configuration of this embodiment are omitted.

Referring to FIG. 2A, the optical pickup device 100 of this embodiment includes: the housing 1; a first partition wall 1a; a second partition wall 1b; the light-emitting element 3; the holder 2 of the light-emitting element 3; and the diffraction grating 6.

The diffraction grating 6 and the semitransparent mirror 9 are provided on an optical path of the laser beam emitted from the light-emitting element 3. The semitransparent mirror 9 is placed inclined to the optical path in the plan view so as to reflect the laser beam in the direction of the objective lens 18 held by the actuator 19.

Referring to FIG. 2B, the housing 1 is shaped into the form of a box having a bottom surface BS and a side surface SS by, for example, resin molding. The first partition wall 1a and the second partition wall 1b are provided inside the housing 1. The light-emitting element 3 and various optical components are housed in the housing 1.

The first partition wall 1a is provided perpendicular to the bottom surface BS of the housing 1 (in the +Df direction) to define two housing portions 10a, 10b inside the housing 1. Similarly, the second partition wall 1b is provided perpendicular to the bottom surface BS of the housing 1 (in the +Df direction) to define two housing portions 10b, 10c inside the housing 1. Although the two partition walls, i.e., the first partition wall 1a and the second partition wall 1b, are shown in this embodiment as an example, partition walls are provided as needed according to the shapes and housing pattern of optical components to be housed in the housing 1.

The first partition wall 1a has a first principal surface S1 and a second principal surface S2 which face the side surface SS of the housing 1. The first partition wall 1a also has a through-hole 5 which penetrates from the first principal surface S1 through the second principal surface S2.

The holder 2 is configured to hold the light-emitting element 3 mounted in a metal frame 31. In addition, the holder 2 has an opening 8 at its end portion in a laser beam output direction, the opening 8 being in the form of, for example, a cylinder and serving as a light path of the laser beam. A portion surrounding the opening 8 is in contact with the first principal surface S1 of the first partition wall 1a, more specifically, is in contact with a portion surrounding the through-hole 5 on the first principal surface S1 side.

Although described in detail later, the diffraction grating 6 is one of the optical components, and including a diffraction grating portion 6a to transmit a laser beam and a diffraction grating holding portion 6b provided in a peripheral portion of the diffraction grating portion 6a and configured to hold the diffraction grating portion 6a. The peripheral portion, i.e., the diffraction grating holding portion 6b of the diffraction grating 6 is in contact with the second principal surface S2 of the first partition wall 1a, more specifically, is in contact with a portion surrounding the through-hole 5 on the second principal surface S2 side.

A press member (a plate spring, for example) 7 is attached to the diffraction grating 6. The diffraction grating 6 is thereby fixed between the first partition wall 1a and the second partition wall 1b while being pressed toward the first partition wall 1a.

In this embodiment, a closed space E is formed by the holder 2, the first partition wall 1a, and the diffraction grating 6. Here, the closed space E means a space (a region indicated by a thin broken line) physically closed to such a degree that the entry of a gas from the outside of the housing 1 in a travel direction of the laser beam (indicated by a solid arrow) emitted from the light-emitting element 3 can be blocked. The optical path of the laser beam from a light-emission point EP of the light-emitting element 3 to the diffraction grating 6 exists inside this closed space E. Further, a terminal portion of the holder 2 also has a configuration of not allowing a gap as much as possible.

This structure makes it possible to block the entry of the gas (outgas) from the outside of the housing 1 in a space between the diffraction grating 6 and the holder 2, which will be described later.

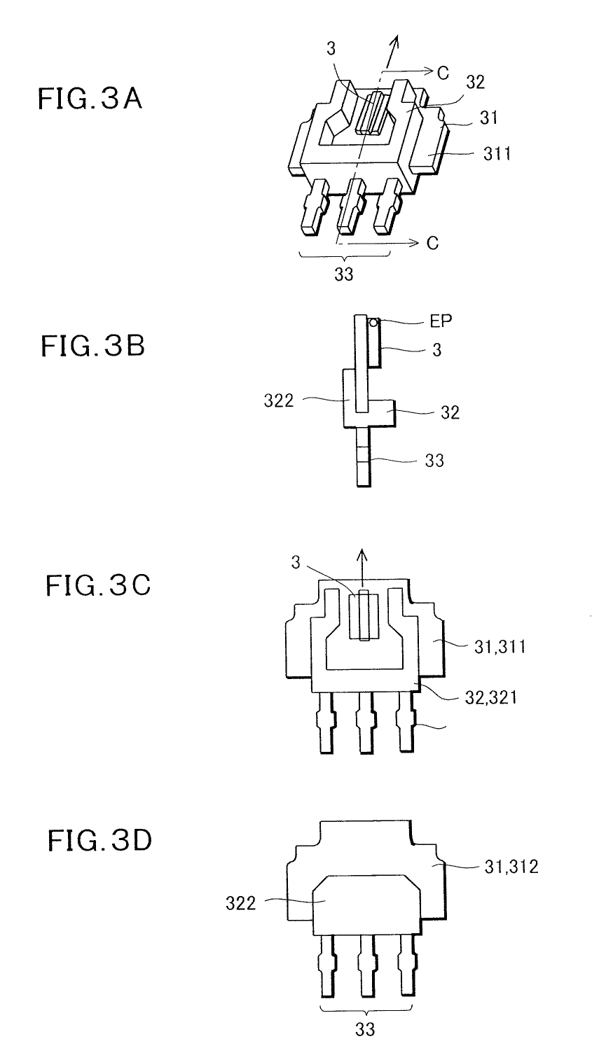

A mounting structure of the light-emitting element 3 is described with reference to FIGS. 3A to 3D. FIG. 3A is a perspective view showing the mounting structure, FIG. 3B is a cross-sectional view of the mounting structure taken along the line c-c of FIG. 3A, FIG. 3C is a plan view showing one surface of the mounting structure on which the light-emitting element 3 is placed, and FIG. 3D is a plan view showing a back surface of the mounting structure shown in FIG. 3C.

The light-emitting element (semiconductor laser diode) 3 of this embodiment is not mounted in a so-called CAN package hermetically sealed by a glass surface and metal. The mounting structure of the light-emitting element 3 is of a so-called frame type in which the bare chip of the light-emitting element 3 is installed (or mounted) in an open base.

Referring to FIGS. 3A and 3B, the light-emitting element 3 is mounted on one principal surface 311 of the metal frame 31. The metal frame 31 is provided with a mold resin layer 32 which surrounds the light-emitting element 3 and is open on the light-emission point side. The mold resin layer 32 is provided to cover continuously the two principal surfaces 311, 312 and one end of the metal frame 31. A terminal 33 to be connected to the light-emitting element 3 is provided at an end portion of the mold resin layer 32.

The mounting structure of the frame type is lower in cost than the CAN package. However, in this structure, a space around the light-emission point EP of the light-emitting element 3 is not hermetically sealed by glass or metal, and is exposed (open) when the element is mounted, unlike in the CAN package.

As shown in FIG. 3B, the other principal surface 322 of the mold resin layer 32 is fixedly attached to the inside of the holder 2, whereby the light-emitting element 3 is held by the holder 2.

Referring to FIGS. 3C and 3D, in the plan view, the shape of the mold resin layer 32 on the one principal surface 311 side of the metal frame 31 is different from that on the other principal surface 312 side of the metal frame 31. More specifically, in the plan view, the mold resin layer 32 is provided in the form of the letter “C” on one principal surface 321 side, and plate-shaped on the other principal surface 322 side.

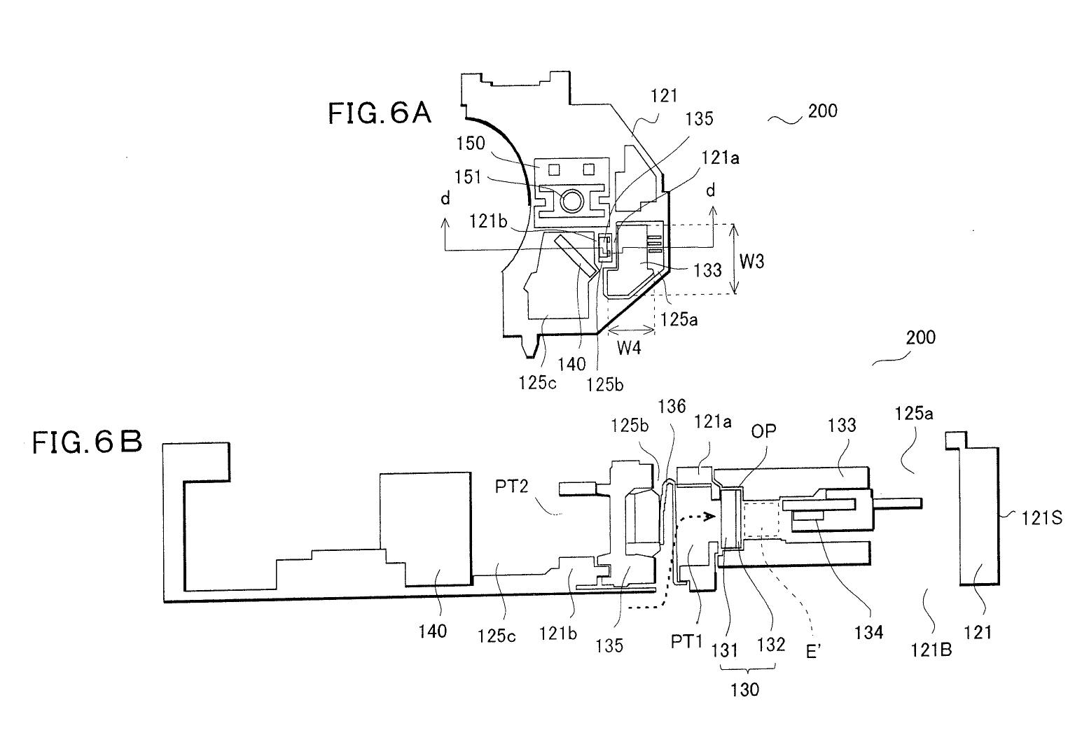

Note that, this embodiment enhances heat dissipation performance as compared with the conventional structure (FIGS. 6A and 6B) also by improving the shape of the holder 2. Specifically, as shown in the plan view of FIG. 6A, the holder 133 of the conventional structure has a complex shape formed of nine sides (the sides opposed to the diffraction grating 135 form the letter “L,” in particular). On the other hand, as shown in the plan view of FIG. 2A, this embodiment employs a simple pentagonal structure formed of five sides (the side opposed to the diffraction grating 6 is linear, in particular), and thereby increases the area of the holder as compared with the conventional structure. More specifically, the area of the holder is increased with a width W1 of the holder 2 in a longitudinal direction thereof made equal to a maximum width W3 of the conventional structure in a longitudinal direction thereof, and with a width W2 of the holder 2 in a lateral direction thereof made equal to a maximum width W4 of the conventional structure in a lateral direction thereof. In this case, needless to say, a proper value is selected for a distance between (the light-emission point ER of) the light-emitting element 3 and the diffraction grating 6.

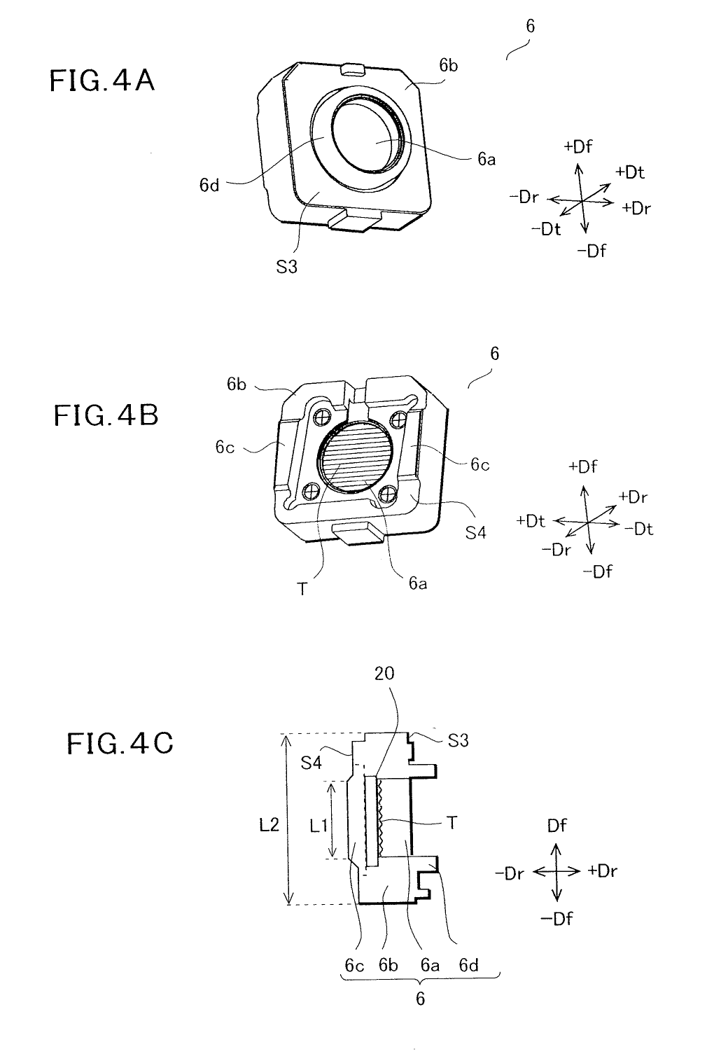

The diffraction grating 6 is described with reference to FIGS. 4A to 4C.

FIGS. 4A to 4C are perspective views showing the diffraction grating 6; FIG. 4A is a perspective view of the diffraction grating 6 seen in a laser beam entering direction (from the +Dr direction), FIG. 4B is a perspective view of the diffraction grating 6 seen in a direction in which the press member 7 contacts the diffraction grating 6 (from the −Dr direction), and FIG. 4C is a cross-sectional view of the diffraction grating 6.

As described above, the diffraction grating 6 as the optical component includes: the diffraction grating portion 6a to transmit a laser beam; the diffraction grating holding portion 6b provided in the peripheral portion of the diffraction grating portion 6a and configured to hold the diffraction grating portion 6a; and a fitting portion 6d.

The diffraction grating portion 6a mentioned above is a portion which has, for example, a (substantially) circular or (substantially) rectangular shape in the plan view seen in the laser beam entering direction and which is provided, in one principal surface thereof, with a groove T in the form of saw teeth, a sine wave, or rectangles for splitting a laser beam, for example. Meanwhile, the diffraction grating holding portion 6b is a portion which is provided in the shape of, for example, an annular, U-shaped, or rectangular frame outside the diffraction grating portion 6a, and which is configured to hold the diffraction grating portion 6a.

The diffraction grating 6 is formed by integrally molding the diffraction grating portion 6a and the diffraction grating holding portion 6b out of a homogeneous material. However, the diffraction grating 6 is not limited to this. Instead, the diffraction grating 6 may be formed by: separately molding the diffraction grating portion 6a and the diffraction grating holding portion 6b; and embedding the diffraction grating portion 6a into the diffraction grating holding portion 6b in a manufacturing step.

The diffraction grating portion 6a and the diffraction grating holding portion 6b are molded out of for example, glass or a hard synthetic resin excellent in optical characteristics and capable of being used for injection molding. Examples of the synthetic resin material include: a polycarbonate being a thermoplastic synthetic resin; and a polymethylmethacrylate (PMMA) resin being an acrylic resin highly transparent and excellent in optical characteristics.

A description is given here of an example of using the diffraction grating 6 made by integrally molding the diffraction grating portion 6a and the diffraction grating holding portion 6b out of a synthetic resin.

The fitting portion 6d protruding from the diffraction grating holding portion 6b (a first principal surface S3) is provided on the first principal surface S3 of the diffraction grating 6. The fitting portion 6d is in the form of a ring surrounding the diffraction grating portion 6a, and is fitted in part of the inner peripheral wall of the through-hole 5 of the first partition wall 1a.

Further, a half-wave plate 20 also made of a resin film is attached to the diffraction grating portion 6a on a second principal surface S4 side. A polarization filter may be attached to the diffraction grating portion 6a in addition to the half-wave plate 20. The half-wave plate 20 (and the polarization filter) may be housed in the housing 1 separately from the diffraction grating 6.

Furthermore, a protruding portion 6c made by partially protruding the diffraction grating holding portion 6b is provided on the second principal surface S4. The protruding portion 6c is a region with which the press member 7 is in contact, and has a flat surface of a length L1 extending in the Df directions. The length L1 is half or more than half a length L2 of the diffraction grating 6 in the Df directions.

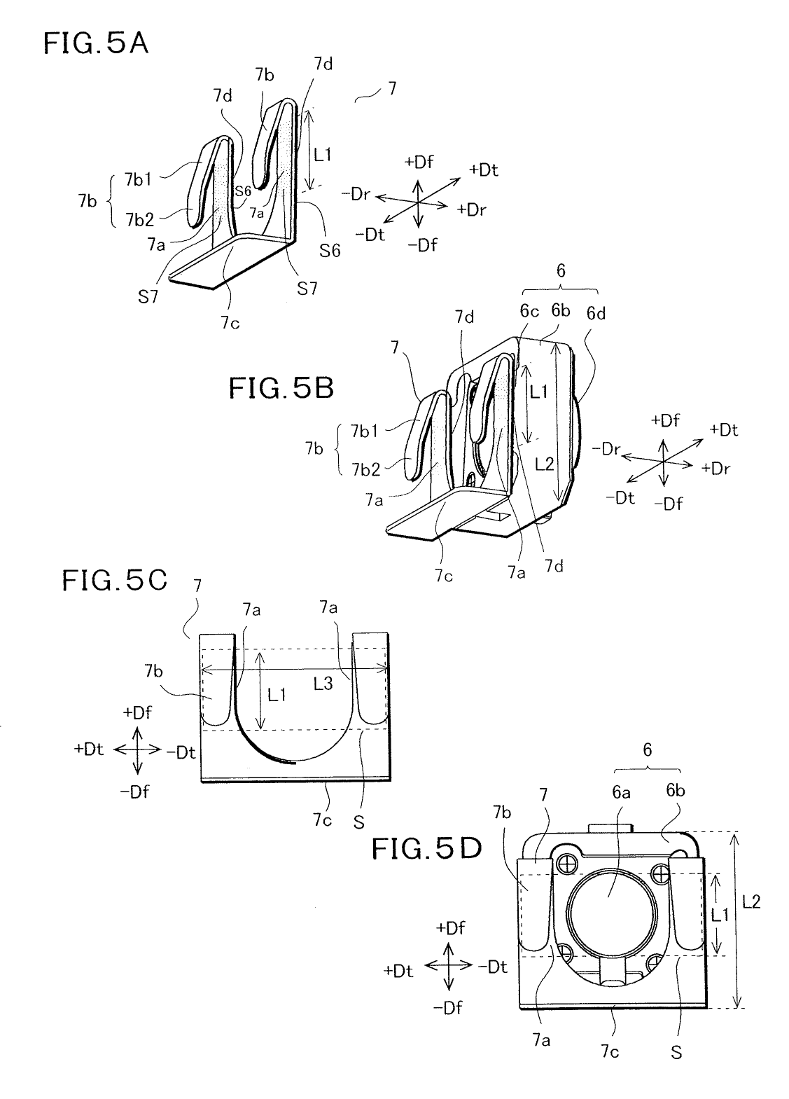

FIGS. 5A to 5D are views for describing the press member 7 configured to press and fix the diffraction grating 6; FIG. 5A is a perspective view showing the press member 7; FIG. 5B is a perspective view of the press member 7 attached to the diffraction grating 6; FIG. 5C is a plan view of the press member 7 seen from the −Dr direction; and FIG. 5D is a plan view of the press member 7 attached to the diffraction grating 6, which is seen from the −Dr direction.

Referring to FIG. 5A, the press member 7 is configured to press and fix the diffraction grating 6 to the first partition wall 1a being a portion to which the diffraction grating 6 is attached, and includes: contact portions 7a; deformation portions 7b coupled to one ends of the respective contact portions 7a and bent to be elastically deformable; and a fixing portion 7c coupled to the other ends of the contact portions 7a and bent perpendicularly to the contact portions 7a. A description is given here of an example of a plate spring made by integrally forming the contact portions 7a, the deformation portions 7b, and the fixing portion 7c by punching and bending a single metal plate into the shape shown in the drawing.

The contact portions 7a are substantially flat plate-shaped portions each having a first principal surface S6 and a second principal surface S7 and including a portion in surface contact with the diffraction grating 6 (a contact surface 7d). Here, the term “substantially flat” means that no bending processing for the purpose of adding a certain function is applied.

The deformation portions 7b are portions continuing to the one ends of the contact portions 7a and bent to be elastically deformable. For example, each of the deformation portions 7b includes: a first deformation portion 7b1 folded back from one end of the contact portion 7a at an acute angle to extend in a direction away from the contact portion 7a toward a side where the fixing portion 7c protrudes; and a second deformation portion 7b2 further bent from a tip end of the first deformation portion 7b1 at an obtuse angle (in a direction toward the contact portion 7a).

The fixing portion 7c is a portion which continues to the other ends of the respective contact portions 7a and protrudes in the −Dr direction in the form of a canopy. The press member 7 is fixed to the housing 1 by inserting this fixing portion 7c into an insertion groove I of the housing 1 (the second partition wall 1b) (see FIG. 2B).

In other words, the deformation portions 7b as a whole and the fixing portion 7c are bent in the same direction with respect to the contact portion 7a (in the −Dr direction) in such a way that their tips face each other.

To put it differently, the two contact portions 7a extend from two ends of the fixing portion 7c in the Dr directions, and the deformation portions 7b are provided to from the extremities of the respective contact portions 7a. Each contact portion 7a is a portion substantially in the form of a rectangle (strap) with the Df directions as its longitudinal direction and having the first principal surface S6 on the +Dr direction side and the second principal surface S7 on the −Dr direction side, and the diffraction grating 6 is in contact with the first principal surface S6. In other words, the contact surface 7d is a surface of the contact portion 7a on the first principal surface S6 side. In addition, the deformation portion 7b and the fixing portion 7c are both bent toward the same principal surface of the contact portion 7a, i.e., toward the second principal surface S7 which is opposite from the diffraction grating 6.

Although the two contact portions 7a extending in the +Df direction from the two ends of the fixing portion 7c in the Dr directions are integrally provided by being coupled in a U shape in this embodiment, these two contact portions 7a may be separately provided at the two ends of the fixing portion 7c in the Dr directions.

The contact portions 7a are in contact with at least opposing two sides of the diffraction grating holding portion 6b, and each deformation portion 7b applies a pressing force to the partition wall in contact with the second deformation portion 7b2 (the second partition wall 1b) and the diffraction grating 6 by being elastically deformed. More specifically, the deformation portion 7b is deformed within its elastic range by an applied force, thereby accumulates elastic energy. Each deformation portion 7b presses the second partition wall 1b and the diffraction grating 6 using this elastic energy.

At least part of the first principal surface S6 of each contact portion 7a serves as the contact surface 7d which is in contact with the diffraction grating holding portion 6b. The contact surfaces 7d are surfaces substantially in flat-to-flat contact with (in surface contact with) two opposing regions of the diffraction grating holding portion 6b (the two protruding portions 6c (see FIG. 4C) in this embodiment), and correspond to hatched regions on the first principal surface S6 side. Although the part of the contact portion 7a serves as the contact surface 7d in this embodiment, the entire contact portion 7a (on the first principal surface S6 side) may serve as the contact surface 7d.

Referring to FIG. 5B, each contact surface 7d in this embodiment is substantially in the form of a rectangle (strap) long in a direction from one end of the contact portion 7a on the deformation portion 7b side to the other end thereof on the fixing portion 7c side (i.e., the Df directions), as shown by the hatching. The length L1 in this direction (the longitudinal direction: Df directions in this embodiment) is half or more than half the length (height) of the diffraction grating 6 in the same direction (Df directions).

Referring to FIGS. 5C and 5D, in the two contact portions 7a, contact surfaces 7d to be in surface contact with the diffraction grating 6 are provided with a sufficiently-long length L1 in its longitudinal direction. With this structure, a load can be applied to the diffraction grating 6 by a surface S defined by two pairs of opposing sides having the length L1 and the length of a distance L3 between outer edges of the contact portions 7a.

For example, if the length L1 of the contact surface 7d is smaller (less than half the length of the diffraction grating in the Df directions as in the case of the conventional example shown in FIG. 6B, for example), the area of the surface S to apply a surface load is accordingly smaller; and if the length L1 is minimized, the contact surface 7d is put into point contact with the diffraction grating 6. In this case, the load applied to the diffraction grating 6 is only a line load or a narrow surface load which is close to the line load. This causes a problem that the diffraction grating 6 deforms and deteriorates the aberration due to uneven application of the pressure.

In this embodiment, the length L1 of the contact surface 7d in surface contact with the part of the diffraction grating holding portion 6b (the protruding portion 6c) is secured to be larger than that in the conventional example. Thereby, the area of the surface S to apply the surface load to the diffraction grating 6 can be secured to be sufficiently large. The area of the surface S to apply the surface load is half or more than half the area of the diffraction grating 6 in the plan view, for example (see FIG. 5D). This enables a pressing force applied to the diffraction grating 6 to be distributed, and thus prevents deformation of the diffraction grating 6. This also enables the diffraction grating 6 to be closely attached to the partition wall 1a of the optical pickup device 100, which will be described later.

Note that the protruding portion 6c does not necessarily have to be provided to the diffraction grating 6. In this case, the contact surface 7d in surface contact with part of the diffraction grating 6 (the diffraction grating holding portion 6b) has only to have the length L1 which is half the length L2 of the diffraction grating 6. In other words, even if there is no protruding portion 6c, the diffraction grating 6 needs to have a flat region of the length L1 enough to secure the surface contact of the diffracting grating 6 with the contact surface 7d.

In addition, when the diffraction grating holding portion 6b is substantially circular, the length L1 of the contact surface 7d may be smaller than that shown in the drawing. However, even in this case, it is preferable to set the length L1 in the Df directions half or more than half the length L2 of the diffraction grating 6.

As described above, the press member 7 suffices if the length L1 of the contact surface 7d in the Df directions is half or more than half the length, in the Df directions, of the diffraction grating 6 which the press member 7 presses. Further, the bent shape of the deformation portion 7b is not limited to the shape shown in the drawing as long as the deformation portion 7b is capable of being elastically deformed.

Further, although the fixing portion 7c and the deformation portion 7b are both bent in the −Dr direction, the fixing portion 7c may be bent in the +Dr direction instead, for example.

In addition, although the contact portions 7a shown in this embodiment as an example are provided in the form of two legs (the letter U) in such a way that their contact surfaces 7a each have a strap shape (rectangular shape), the contact portions 7a may be provided in a curve shape (arc shape) along the outer periphery of the substantially circular diffraction grating portion 6a. Further, the contact portions 7a may be provided continuously in a ring shape or a rectangular shape instead of being provided separately. Similarly, the deformation portions 7b may be provided continuously in a U shape, a ring shape, or a rectangular shape instead of being provided separately.

Furthermore, although a description has been given of the press member 7 formed of a single metal plate as an example, the press member 7 may be formed in the shape shown in FIG. 5A by processing and overlapping multiple metal plates, for example.

Moreover, the press member 7 may be another elastic member in lieu of the plate spring. Resin or the like which is hard and elastic and whose pressing force is less likely to change due to expansion and contraction with temperature, for example, may be considered as the other elastic member.

Referring to FIGS. 2A and 2B again, the portion surrounding the opening 8 of the holder 2 is in contact with the first principal surface S1 (the principal surface on the +Dr side) of the first partition wall 1a. The second principal surface S2 (the principal surface on the −Dr side) of the first partition wall 1a is in contact with the first principal surface S3 (the principal surface on the +Dr side) of the diffraction grating 6 (the diffraction grating holding portion 6b). The press member 7 is in contact with the second principal surface S4 (the principal surface on the −Dr side) of the diffraction grating 6 (the diffraction grating holding portion 6b). The fixing portion 7c of the press member 7 is inserted into the insertion groove I provided below the second partition wall 1b, and is in contact with the first principal surface S5 (the principal surface on the +Dr side) of the second partition wall 1b. The diffraction grating 6 is pressed in the +Dr direction by the press member 7, and is thereby fixed in the space between the first partition wall 1a and the second partition wall 1b (the housing portion 10b).

In other words, the holder 2 and the diffraction grating 6 are put in close contact with the two principal surfaces of the first partition wall 1a. In particular, the fitting portion 6d which protrudes from the diffraction grating holding portion 6b (the first principal surface S3) in the +Dr direction is provided to the first principal surface S3 of the diffraction grating 6, and is fitted in the part of the inner peripheral wall of the through-hole 5 of the first partition wall 1a. To put it simply, the fully close contact with the first partition wall 1a is secured for the diffraction grating 6.

In addition, the length L1 of the contact surface 7d of the press member 7, which is in surface contact with the diffraction grating 6, is larger than that in the conventional structure (see FIGS. 5A to 5D). In other words, the area of the surface S to apply a surface load to the diffraction grating 6 is larger than that in the conventional structure. Thereby, the pressing force applied to the diffraction grating 6 can be distributed evenly (uniformly). This makes it possible to prevent the deformation of the diffraction grating 6 and thereby suppress the deterioration of aberration, and to improve the quality of the close contact between the diffraction grating 6 and the first partition wall 1a.

With the above structure, the closed space E is formed by a portion of the holder 2 near the opening 8, the first partition wall 1a, and the diffraction grating 6. As described previously, the closed space E is a space physically closed, and is a space hermetically sealed (closed) to such a degree that the entry of the gas from the outside of the housing 1 can be blocked. An optical path of the laser beam (indicated by the thick arrow) from the light-emission point EP to the diffraction grating 6 (the diffraction grating portion 6a on the first principal surface S3 side) exists inside this closed space E.

Note that, needless to say, the laser beam passes through the diffraction grating 6 even in the closed space. Specifically, the laser beam emitted from the light-emission point EP of the light-emitting element 3 passes through the opening 8, the through-hole 5, and the diffraction grating 6, and is then reflected by the semitransparent mirror 9 in the direction of the objective lens 18 (see FIG. 2A). The diffraction grating portion 6a of the diffraction grating 6 is located on the optical path of the laser beam.

As described previously, the light-emitting element 3 of this embodiment is mounted in the open package and held by the holder 2. Thus, unlike in a light-emitting element mounted in a CAN package, the laser beam emitted from the light-emission point EP is not blocked by glass or the like before outputted to the outside of the holder 2 through the opening 8. In other words, the light beam from the light-emission point EP passes through the opening 8 and the through-hole 5 (the closed space E) and enters the diffraction grating 6 directly without passing through any physical material such as a glass plate, a film, or a resin.

Even with the above structure, the outgas having entered the inside of the housing as shown by a broken arrow can be prevented from reaching around the light-emission point EP by forming the space E (closed space) which is closed by the first partition wall 1a and the diffraction grating 6 outside the holder 2.

Moreover, since the bottom surface BS of the housing 1 has no opening in its portion between the diffraction grating 6 and the holder 2, the entry of a gas which would otherwise occur through the bottom surface BS is blocked in the portion between the diffraction grating 6 and the holder 2. With these features, in this embodiment, the entry of the gas (outgas) from the outside of the housing 1 can be blocked in the space between the diffraction grating 6 and the holder 2.

In terms of structural characteristics, the closed space E′ does not necessarily have to be formed inside the holder unlike in the conventional structure as long as the outgas can be prevented from flowing to around the light-emission point EP can be blocked. In this embodiment, the closed space E is formed by the holder 2, the first partition wall 1a, and the diffraction grating 6. In addition, the film-shaped half-wave plate 20 is provided to the diffraction grating 6. This makes it possible to eliminate an optical component (composite component) using glass as a base material, which is provided inside the holder in the conventional structure to block the outgas (to form the closed space), and thereby to reduce the cost of an optical pickup device.

Further, no polarization filter need be placed in the holder whose temperature becomes high. Thus, the deterioration of a polarization filter can be prevented.

Note that, this embodiment does not form the closed space E′ inside the holder by using the composite component and the holder unlike in the conventional structure (FIGS. 6A and 6B), but form the closed space E inside and outside the holder 2 by using the holder 2, the first partition wall 1a, and the diffraction grating 6.

In other words, the half-wave plate 20 (and the polarization filter) does not have to be provided in the diffraction grating 6. Even when these components are attached to another optical component or housed in the housing 1 separately, for example, the closed space E can be formed by the diffraction grating 6, the first partition wall 1a, and the holder 2, and the entry of the outgas can be thereby prevented.

Note that the optical system of the optical pickup device 100 of this embodiment is merely an example, and the aspects of this embodiment can be implemented in any optical system in the same way as long as the optical system is configured to record or read data by: focusing a laser beam from a light-emitting element with an objective lens; irradiating an optical disk with the laser beam; and detecting the laser beam reflected off the optical disk.

For example, the aspects of this embodiment can be implemented in the same way and the same effect can be obtained in: an optical system which uses a single laser diode configured to emit laser beams of three different wavelengths, and guides the laser beams of three wavelengths toward one objective lens; an optical system which uses three separate laser diodes, and guides laser beams toward one or two objective lenses; and an optical system which guides a laser beam of a single wavelength or laser beams of two wavelengths toward one or two objective lenses.

According to the present invention, the entry of an outgas inside the holder can be prevented even when a (composite) component using glass as a base material is eliminated or the component is made of a different material.

Specifically, on the two principal surfaces of the housing partition wall having the through-hole through which a laser beam passes, the diffraction grating and the holder are placed in contact with the principal surfaces respectively. Thereby, the closed space is formed inside and outside the holder by the diffraction grating and the partition wall. The film-shaped half-wave plate is provided to one of the principal surfaces of the diffraction grating which is farther from the holder, for example.

This makes it possible to eliminate the optical component using glass as a base material, which is used in the conventional structure to form the closed space in the holder, and thereby to reduce the cost of an optical pickup device.

Further, a polarization filter does not have to be placed in the holder whose temperature becomes high. Thus, the polarization filter can be prevented from deteriorating.

Furthermore, the shape of the press member (plate spring) configured to press the diffraction grating to the partition wall is improved in such a way that: the area of the press member to be in flat-to-flat contact with the diffraction grating is increased as compared with the conventional one; and a load to be applied to the diffraction grating is changed from a line (point) load to a surface load. Thus, a pressing force applied to the diffraction grating can be distributed, and the deformation of the diffraction grating can be thereby suppressed.

What is claimed is:

1. An optical pickup device comprising:
a first partition wall defining two housing portions inside a housing, and including a through-hole penetrating from a first principal surface to a second principal surface of the first partition wall;
a holder holding a light-emitting element, and including an opening through which a light beam from the light-emitting element is to pass, a portion of the holder surrounding the opening being in contact with a portion of the first principal surface surrounding the through-hole; and
a diffraction grating whose peripheral portion is in contact with a portion of the second principal surface surrounding the through-hole, wherein
the holder, the first partition wall, and the diffraction grating together form a closed space, and
an optical path of the light beam from a light-emission point of the light-emitting element to the diffraction grating is inside the space.

2. The optical pickup device according to claim 1, wherein the light beam emitted from the light-emission point passes through the opening and the through-hole, and enters the diffraction grating directly.

3. The optical pickup device according to any one of claims 1 and 2, wherein the space is closed hermetically enough to block the entry of a gas from an outside of the housing.

4. The optical pickup device according to any one of claims 1 and 2, wherein part of the diffraction grating on a first principal surface side thereof is fitted into part of the through-hole.

5. The optical pickup device according to claim 4, further comprising:
a second partition wall provided at a second principal surface side of the diffraction grating, wherein
the diffraction grating is fixed to the housing by a press member placed between the diffraction grating and the second partition wall.

6. The optical pickup device according to claim 5, wherein
the press member has a contact surface in flat-to-flat contact with a peripheral portion of the diffraction grating, and
a length of the contact surface in a longitudinal direction is half or more than half a length of the diffraction grating in the longitudinal direction.

7. The optical pickup device according to claim 1, wherein the holder is an open package from which the light-emitting element mounted therein is exposed at least partially.
